(19) United States
(12) Patent Application Publication
(10) Pub. No.: US 2024/0271435 A1
(43) Pub. Date: Aug. 15, 2024

(54) SCREED PLUG, SCREEDING GUIDE AND SCREEDING METHOD

(71) Applicant: PERFECRETE PTY LTD, Sydney, New South Wales (AU)

(72) Inventor: Rob FORD, Sydney, New South Wales (AU)

(73) Assignee: PERFECRETE PTY LTD, Sydney, New South Wales (AU)

(21) Appl. No.: 18/563,587

(22) PCT Filed: May 27, 2021
(86) PCT No.: PCT/AU2021/050510

§ 371 Date: Nov. 22, 2023

(51) Int. Cl. E04F 21/24; F16L 55/11

(52) U.S. Cl. CPC E04F 21/241; F16L 55/11

(57) ABSTRACT

A screed plug (10) for placement in an open end of a conduit (70) comprises: a rigid top plate (18); a second surface (14); and at least one side wall (16) extending between the top plate (18) and the second surface (14); a recess (20) formed in the top plate (18); and a handle (22) for manipulating the screed plug (10). The handle (22) is houseable within the recess (20) and is reversibly movable from at least a first position within the recess (20) and a second position projecting from the recess (20).

### TECHNICAL FIELD

The present disclosure relates to a screed plug, a screeding guide and a screeding method.

### BACKGROUND

When screeding the surface of an area which includes a conduit, such as a drain, around which the screed will be laid, the conduit is typically installed in the area prior to screeding. For example, when a house is being constructed, water pipes, drain pipes, sewer pipes and the like are usually installed prior to a concrete base being poured over and around the pipes and drains. In such cases, vertically extending sections of the drain pipes and sewer pipes, for example, will be laid extending upward to a height well above the intended level of the concrete base. This has the advantage of allowing the pipes to be cut to an appropriate height after the concrete base has been laid. In addition, because the open ends of the pipes are higher than the level of the concrete, there is less opportunity for wet concrete and other materials to inadvertently enter the pipes.

After the concrete base has been laid, the individual walls of rooms (for example, the bathroom or the laundry) may be erected. Then, in rooms having a drain (e.g., the bathroom, or the laundry), a layer of screed may be laid around the drain pipe. In order for water and other liquids to flow toward the drain pipe without pooling when the flooring is completed, the surface of the screed will be formed sloping toward the drain pipe.

In cases where the drain pipe projects through the concrete base to a height above the intended height of the layer of screed, the pipe itself will have been in the way during the process of levelling the surface of the wet concrete forming the base. In addition, the pipe may also make establishing an even sloping surface on the layer of screed difficult because the pipe will be in the way and limit movement of the screeding beam (or screed rail) around the pipe. Therefore, prior to screeding, the pipe may be cut to its intended height close to or below the intended height of the laid screed.

However, in cases where the drain pipe projects to (or below) the intended height of the laid screed, it is likely that some screeding material will be inadvertently spread into the opening of the pipe during the screeding process. This is a problem because screed which falls into the pipe during the screeding process may adhere to the inside of the pipe and harden and may block or restrict the flow of liquids in the pipe. To avoid this problem, it is common practice to put a piece of material (a rag, paper, or the like) in the opening of the pipe. At the end of the screeding process, the piece of material is typically removed before the layer of screed dries.

In addition, in order to establish the slope of the surface of the screed, beams of wood are cut to have an inclined profile corresponding to the intended slope of the screed. For example, when laying screed for a square shower recess where the drain is positioned toward the middle (or away from an edge of the show recess), four pieces of wood will typically be used. The pieces of wood will be laid evenly spaced around the drain pipe (for example, about 90 degrees apart), each piece of wood being positioned with one end (the end with the lowest profile) at the opening of the drain pipe and the other end (the end with the highest profile) at one of the corners of the shower recess. This results in four roughly triangular areas each having an apex at the drain opening. As a result, each piece of wood will be cut to have the appropriate length (matching the length from the corner to the drain pipe). In addition, each piece of wood will be cut to have a slope corresponding to the intended slope of the screed along the particular piece of wood. The piece of material is put in the end of the drain pipe and the four pieces of wood are put in place. Then, the screeding material is spread in the four triangular areas between the pieces of wood. The ends of a screeding rail or similar straight edged beam (for example, beam of wood) are aligned with the pieces of wood and passed back and forth over the screeding material in order to create an even and inclined surface from the edge of the shower recess to the drain opening. Thereafter, the cut pieces of wood are removed (leaving four un-screeded channels in the laid screed) and the screed is left to dry. Once the laid screed has dried, the un-screeded channels are filled with screeding material using the surrounding dried screed as a guide to the height of the screed in the channels. The newly laid screed in the channels is then left to dry.

After all the screed has dried, the surface of the screed can be further treated, for example, a layer of adhesive may be applied and then tiles laid over the screed. A drain cover can be installed over the opening of the drain pipe.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

According to the present disclosure, there is provided a screed plug for placement in an open end of a conduit, the screed plug comprising: a first surface; a second surface; and at least one side wall extending between the first surface and the second surface; a recess formed in the first surface; and a handle for manipulating the screed plug, the handle being movable from at least a first position within the recess and a second position projecting from the recess.

At least a part of the at least one side wall may comprise a resiliently deformable material for engaging an internal wall of the conduit to hinder movement of the screed plug relative to the conduit. The resiliently deformable material may hinder movement of the screed plug relative to the conduit due to an interference fit between the at least one side wall and the internal wall of the conduit. For example, the resiliently deformable material may hinder removal of the screed plug from the conduit or resist downward pressure on the screed plug during insertion of the screed plug into the conduit. It is to be noted that while movement may be hindered or resisted, the insertion and removal of the screed plug into and out of the conduit is not prevented.

The screed plug may have a top plate and the top surface of the top plate may be the first surface of the screed plug.

The screed plug may have a body and a wall of the body may form at least a part of the at least one side wall.

The resiliently deformable material may be formed from any one of: polyethylene, polythene (PE), poly(methylene), polyethylene sheet, high density polyethene (HDPE), polystyrene (PS), expanded polystyrene, extruded polystyrene foam (XTR), 100% closed cell foam (XPS), closed cell foam ethylene vinyl acetate (EVA) and blended copolymers, natural or synthetic cork, compressed paper, OEM rubber, nitrile (NBR) rubber, Buna-N and acrylonitrile butadiene rubber, and polypropylene (PP). For example, the resiliently formed material may be a high density polyethene (HDPE) foam.

The handle may be in the form of a screw having a head and a shaft and the handle may be moved from the first position to the second position by rotating the handle.

The screed plug may further comprise a receiving member into or onto which the shaft of the handle is reversibly screwed. The receiving member may be in the form of a winged nut. The winged nut may be open at each end such that the shaft of the handle is extendible through the winged nut.

The screed plug may further comprise a bottom plate, a bottom surface of the bottom plate forming part of the second surface. The wing nut and the bottom plate may be integrally formed.

The receiving member may be integrally formed with the top plate. Furthermore, the receiving member may be integrally formed with both the bottom plate and the top plate.

The body may be comprised entirely of the resiliently deformable material.

Also disclosed herein is a screeding guide comprising: a wall member having a first end and a second end; and a guide arm connected at a first end to the wall member.

The guide arm may comprise a straight portion which is connected to the wall member and a curved portion which is connected to the straight portion. At least a part of the guide arm may be perforated. Furthermore, at least a part of the wall member may be perforated. The size of the perforations may be, for example, in the range of from 1 to 3 mm.

The straight portion of the screeding guide may extend substantially orthogonally to the wall member. The guide arm may be connected to the wall member at the first end of the wall member.

A curve of the curved portion corresponds to an arc of a circle. The radius of the circle may be 7 mm, for example.

The screeding guide may further comprise a base extending from the second end of the wall member.

The screeding guide may further comprise an adhesive material for adhering the screeding guide to a surface. The adhesive material may be provided on at least one of the wall member and the base.

Also disclosed herein is a screeding method for screeding an area including a conduit having an opening. The method comprising the steps of: arranging at least one screeding guide in an area to be screeded, putting a screeding material on the area to be screeded, levelling a surface of the screed material using a beam; wherein, during the step of levelling, a height of the screed material is established by aligning the beam with a surface of the at least one screeding guide and a guide associated with the conduit.

The guide associated with the conduit may be a rim of the conduit. The method may further include the step of cutting the conduit so that a height of the rim corresponds to an intended height of laid screed at the conduit.

The method may further include a step of covering the opening of the conduit prior to the step of levelling the surface of the screed material. The step of covering the opening may include positioning a plug or cover in the opening of the conduit and a surface of the plug or cover forms the guide associated with the conduit.

The step of covering the opening of the conduit may be carried out before the step of arranging the at least one screeding guide, and the step of positioning the plug or cover in the opening of the conduit may include adjusting a position of the plug or cover such that the surface of the plug or cover corresponds to an intended height of a substrate at the conduit.

The screeding method may further comprise the step of: forming the substrate around the conduit by laying a substrate material around the conduit and levelling the surface of the substrate material using the surface of the plug or cover as a guide for the height of the substrate at the conduit.

The screeding method may further comprise, after the step of forming the substrate, further adjusting the position of the plug or cover such that the surface of the plug or cover corresponds to an intended height of the laid screed at the conduit.

The screeding method may further comprising the steps of: positioning a wall element directly or indirectly against the at least one screeding guide. The step of positioning the wall element directly or indirectly against the at least one guide may be carried out after the step of levelling the surface of the screeding material using the beam.

In some embodiments, the at least one screeding guide may be fixed directly or indirectly to a wall element. For example, this may be the case when the method is carried out in an already existing room or building.

The screeding method may comprise, after the step of levelling the surface of the screeding material using the beam, the step of: laying a further material directly or indirectly over the screeding material. The further material may include tiles.

The step of laying a further material may be carried out after the step of positioning the wall element against the guide.

The screeding guide may be a screeding guide having one or more of the features described above.

The plug or cover may be a screed plug having one or more of the features described above. In that case, the step of further adjusting the position of the plug or cover may include moving the handle of the screed plug from the first position within the recess to the second position projecting from the recess.

According to the present disclosure, there is provided a screed plug for placement in an open end of a conduit, the screed plug comprising: a first surface; a second surface; and at least one side wall extending between the first surface and the second surface; wherein at least a part of the at least one side wall comprises a resiliently deformable material for engaging an internal wall of the conduit to hinder movement of the screed plug relative to the conduit. The resiliently deformable material may hinder movement of the screed plug relative to the conduit due to an interference fit between the at least one side wall and the internal wall of the conduit. The screed plug may have other features as described above. The screed plug according to this embodiment may also be used in the method described above.

### BRIEF DESCRIPTION OF DRAWINGS

FIG. 1 is perspective view of a screed plug according to an embodiment disclosed herein.

FIG. 2 is a plan view of the screed plug shown in FIG. 1.

FIG. 3 is a side view of the screed plug shown in FIG. 1.

FIG. 4 is bottom view of the screed plug shown in FIG. 1.

FIG. 5 is an exploded view of the screed plug.

FIG. 6 is a perspective view of the screed plug inserted into the opening of a conduit.

FIG. 7 is a side view of the screed plug inserted into the opening of a conduit and with the handle raised.

FIG. 8 is a perspective view of the screed plug partially inserted into the opening of a conduit with the handle raised.

FIG. 9 is vertical cross section through the screed plug shown in FIG. 1 inserted into a conduit and with the handle raised.

FIG. 10 is a perspective view of a screeding guide according to an embodiment.

FIG. 11 is a cross-section through the screeding guide.

FIG. 12 is a cross-section through a screeding guide according to another embodiment.

FIG. 13 is a cross section through an area containing a conduit prior to the pouring of a concrete base.

FIG. 14 is cross-section through an area containing a conduit after a concrete base has been formed.

FIG. 15 is a cross-section through an area containing a conduit after screeding guides have been positioned on a concrete base.

FIG. 16 is a cross-section through an area containing a conduit after screeding guides have been positioned on a concrete base as shown in FIG. 15 with a screeding beam.

FIG. 17 is a perspective view of an area prior to screeding.

FIG. 18 is a cross-section through the area after screeding.

FIG. 19 is a cross-section through the area shown in FIG. 18 after the installation of wall elements.

FIG. 20 is a cross-section through the area shown in FIG. 19 after tiles have been laid over the screed.

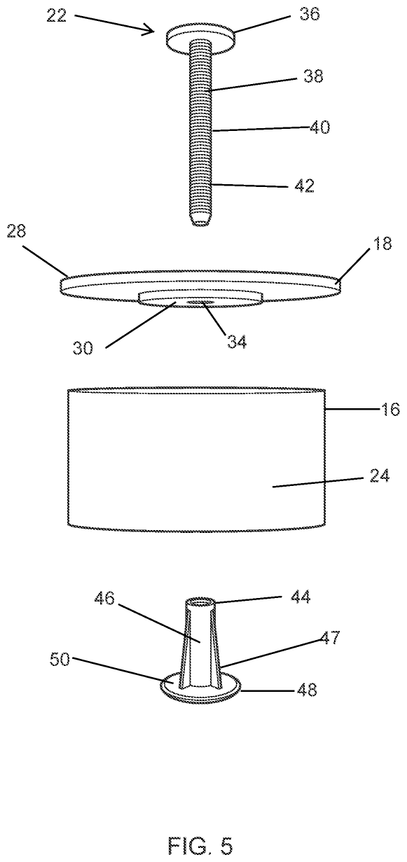

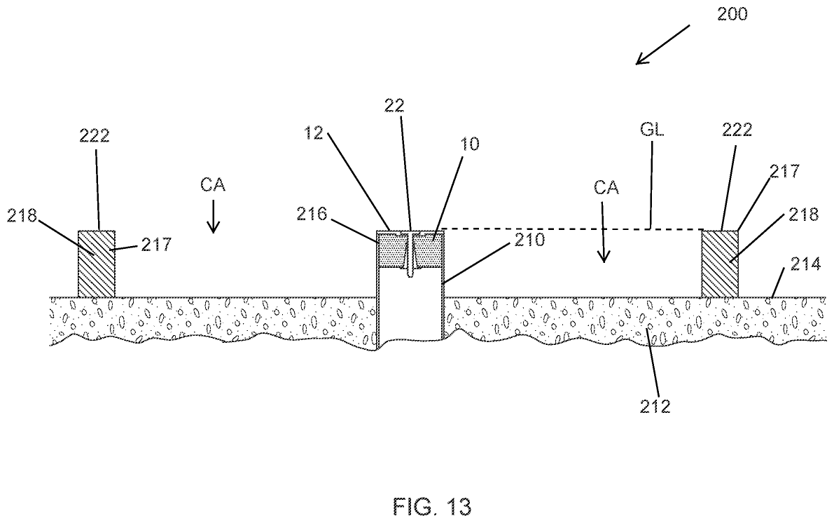

It should be noted that the drawings are schematic and are intended to show the features of the embodiments disclosed herein. In that regard, elements shown in the drawings are not drawn to scale. In addition, in this description, reference is made in some instances to “top”, “bottom”, “upper”, “lower”, “above”, “below”, etc. In such situations and except where otherwise indicated, these terms should be understood in light of the arrangements shown in the drawings (for example, as shown FIGS. 5, 8, and 9—where up is toward the top of the page and down is toward the bottom of the page). For example, in FIGS. 13 to 19, “down” or “downward” indicates the direction toward the ground and “up” and “upward” indicate the direction away from the ground. It should be understood that the screed plug could also be used in conduits with openings which are angled, directed to the side or, in some situations, even downward and in such cases the orientation of the screed plug may be such that the first surface (see below) is not substantially horizontal and it might be directed to the side or may face in another direction.

### DESCRIPTION OF EMBODIMENTS

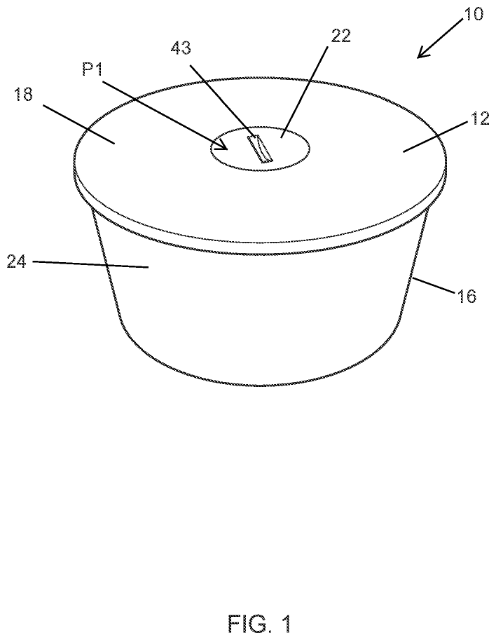

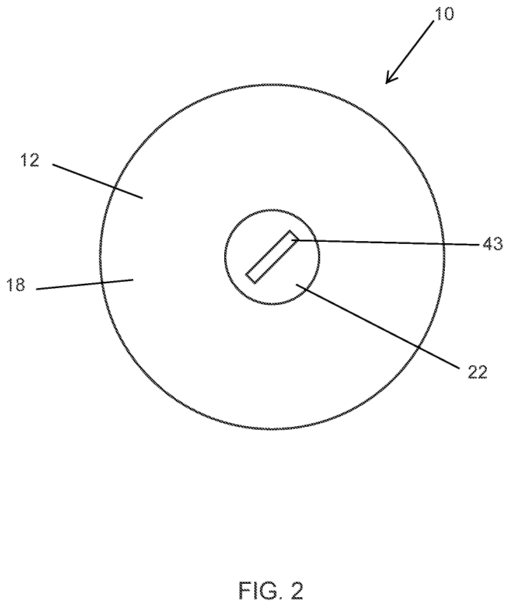

With reference to FIGS. 1 to 5, 8 and 9, reference number 10 generally designates an embodiment of a screed plug. The screed plug 10 has a first surface 12, a second surface 14, and a side wall 16 which extends between the first surface 12 and the second surface 14. The screed plug 10 includes a top plate 18 and the top surface 12 of the top plate 18 corresponds to the first surface 12.

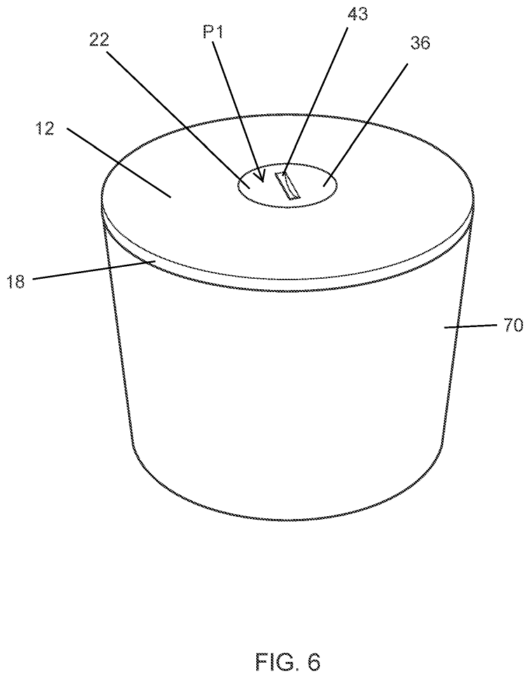

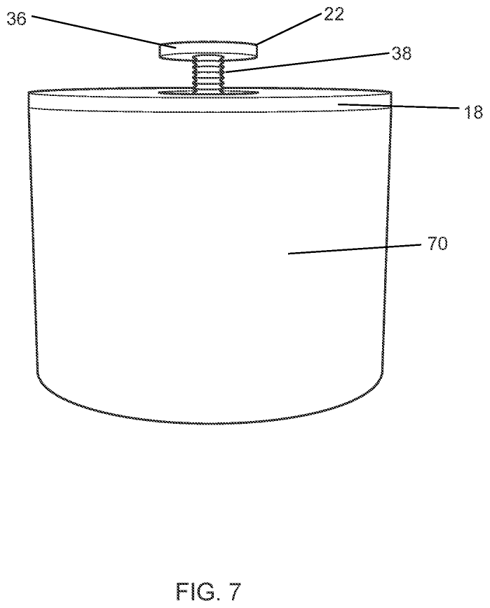

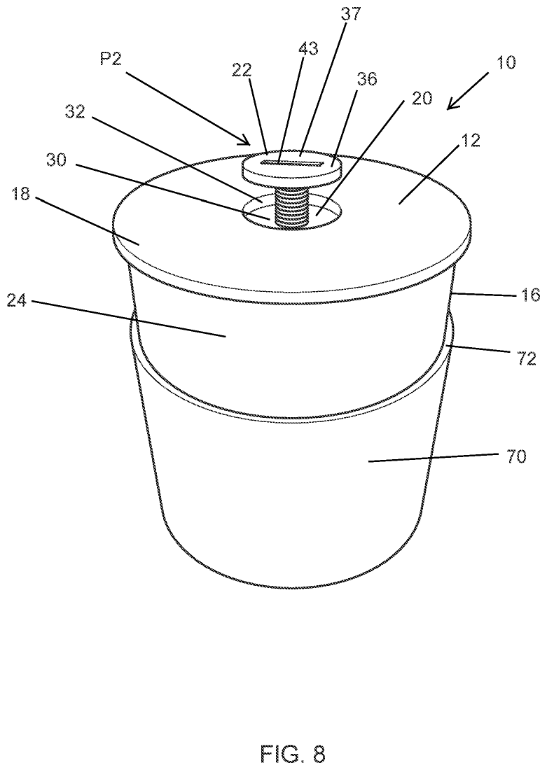

As can be seen in FIG. 8, in this embodiment, a recess 20 is formed in the top surface 12 of the top plate 18. The screed plug 10 also includes a handle 22 which can be used to manipulate or manoeuvre the screed plug 10. The handle 22 can be moved from a first position P1 within the recess 20 (see for example FIGS. 1 and 6) to a second position P2 (see for example FIGS. 7, 8 and 9) projecting from the recess 20. As will be explained later, the height of the handle 22 relative to the first surface 12 can be adjusted through a range of heights.

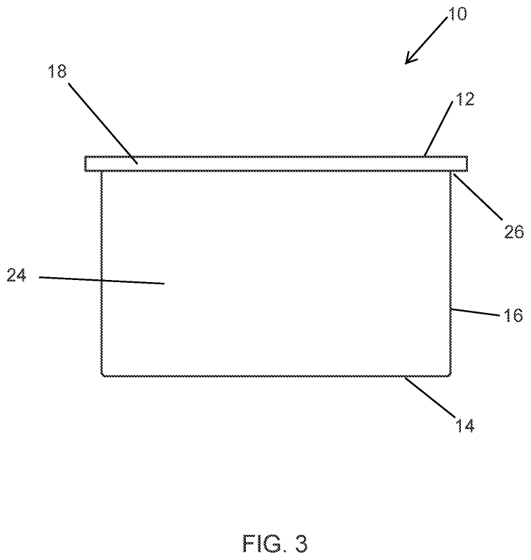

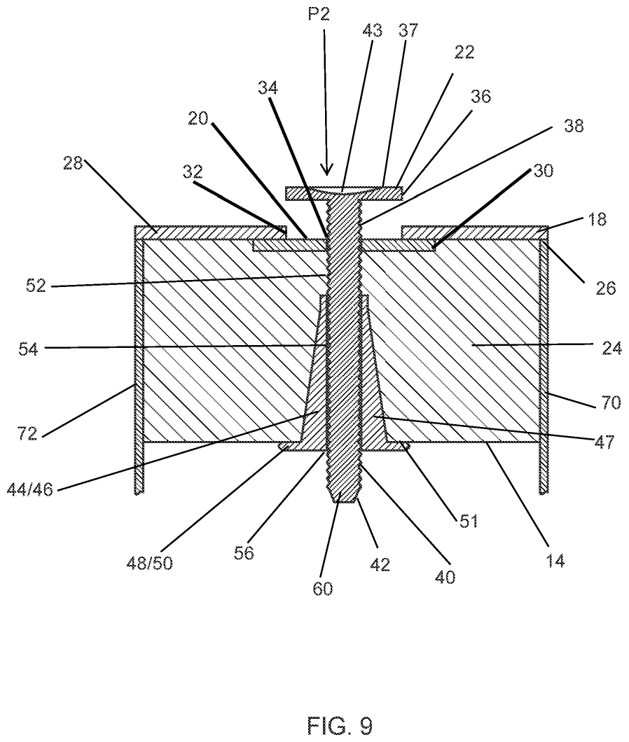

The screed plug 10 includes a body 24. In this embodiment, a wall of the body 24 corresponds to the side wall 16 of the screed plug 10. As can be seen in FIG. 3, the top plate 18 is larger in diameter than the body 24. This difference in diameter results in the side wall 16 being stepped inward at indent 26 where the top plate 18 meets the body 24. As will be explained in more detail below, the difference in diameter between the top plate 18 and the body 24 generally corresponds to the thickness of the wall of the conduit 70 into which the screed plug 10 will be inserted (see FIGS. 8 and 9).

As can best be seen from FIGS. 5 and 8, the top plate 18 is formed from a first disc 28 and a second disc 30. The second disc 30 is smaller in diameter than the first disc 28. The first disc 28 has a hole 32 in its centre (see FIG. 9). The second disc 30 is positioned below (based on the orientation shown in FIGS. 5 and 8) the first disc 28 and has a hole 34 in its centre. The hole 34 in the second disc 30 is smaller in diameter than the hole 32 in the first disc 28. The recess 20 is defined by the edges of the hole 32 and the top surface of the second disc 30 exposed through the hole 32.

As described above, in the embodiment shown in FIGS. 5 and 8, the top plate 18 includes the first disc 28 and the second disc 30. However, it would also be possible for the top plate 18 to be made from a single integrally formed piece.

As can be seen in FIGS. 5, 8 and 9, in this embodiment, the handle 22 has an overall screw-like shape. The handle 22 includes a head 36 and a shaft 38. The shaft 38 has a screw thread 40 on its outer surface 42. In addition, there is a groove 43 formed in the top surface 37 of the head 36. In a similar manner to a screw, a screw driver or other suitably shaped tool can be used to turn the handle 22 around its longitudinal axis. In that regard, the groove may be replaced with a recess having a different shape which could be engaged by other tools such as, for example, a hexagonal shaped screw driver.

With reference to FIGS. 5 and 9, the screed plug 10 includes a receiving member 44 in the form of a winged nut 46. The screed plug 10 includes a bottom plate 48. In this embodiment, the bottom plate 48 is integrally formed with the winged nut 46 and is in the form of a flange 50 which extends laterally outward over part of the lower surface 51 of the body 24.

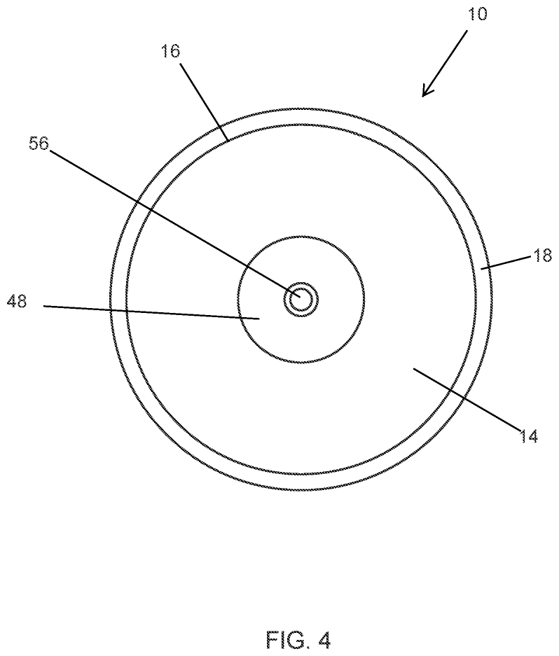

As can best be understood from FIG. 9, in the embodiment shown in FIG. 9, there is a hole 52 which passes through the centre of the body 24. The hole 52 is aligned with the hole 34 in the second disc 30 of the top plate 18. In addition, the winged nut 46 is also aligned with the hole 34 and the hole 52 such that the shaft 38 of the handle 22 passes through the hole 34 and the hole 52 and through the winged nut 46. The winged nut 46 has an internal screw thread 54 which engages the screw thread 40 on the outer surface 42 of the shaft 38. In the embodiment shown in FIG. 9, there is no screw thread on the surface of the hole 52. As can also be seen in FIGS. 4 and 9, the bottom plate 48 also has a hole 56 such that the shaft 38 of the handle 22 can pass through the bottom plate 48.

During the assembly process, the shaft 38 is inserted through holes 34 and 52 and into the opening of the winged nut 46. By turning the handle 22, the handle 22 is screwed into the winged nut 46 and the height of the head 36 relative to the top plate 18 is reduced. When the handle 22 is screwed in fully, the head 36 will be positioned within the recess 20 and, in this embodiment, the top surface 37 of the head 36 will be level with the top surface 12 of the top plate 18 (see, for example, FIGS. 1, 2, 3, and 6). In addition, in this embodiment, the end 60 of the shaft 38 will extend through the bottom plate 48 (see, for example, FIG. 9). Furthermore, by unscrewing the handle 22, the head 36 can be moved from its position (P1) within the recess 20 (a first position) to a position (P2) projecting from the recess 20 (a second position) (see, for example, FIGS. 7 to 9). It will be appreciated that due to this screwing process, there will be a range of positions for the head 36 of the handle 22 from being fully within the recess 12 to being fully extended from the recess 20. It will also be appreciated that there will be a point at which the unscrewing process will disengage the shaft 38 from the winged nut 46 allowing the handle 22 to be fully removed from the screed plug 10. Disengaging the handle 22 from the winged nut 46 such that the handle 22 can be removed is not part of the normal use of the screed plug 10 (see below). This removal can be prevented by inserting a pin (not shown in the Figures) through the end 60 of the shaft 38 or by otherwise changing the shape of the end 60 of the shaft 38 after assembly such that the end 60 of the shaft 38 will not be able to pass back through the hole 56 in the bottom plate 48 or through the winged nut 46.

In this embodiment, the shaft 38 of the handle 22 screwed through the top plate 18, the body 24 and the winged nut 46 keeps these elements together and aligned. The top plate 18 may also be fixed to the body 24 by an adhesive (not shown), The winged nut 46 and bottom plate 48 may also be fixed to the body by adhesive.

In FIGS. 6, 7 and 9, the screed plug 10 is shown fully inserted into a conduit 70, for example, a pipe for a drain or a sewer. In FIG. 8, the screed plug 10 is shown partially inserted or partially withdrawn from the conduit 70.

In addition, as described above, in FIGS. 1, 2, 3 and 6, the handle 22 has been screwed in so that the head 36 is within the recess 20. As will be apparent from the method described below, this is advantageous as the top surface 37 of the head 36 of the handle 22 can be made flush with the top surface 12 of the screed plug 10, making the top surface 12 of the screed plug 10 flat and without raised sections or irregularities.

In FIG. 9, the thicknesses of the first disc 28 and the second disc 30 of the top plate 18 and the thickness of the wall 72 of the conduit 70 appear to be different. However, as explained above, the drawings are diagrammatic and not to scale and the relative thicknesses may vary. For example, each of the first disc 28 and the second disc 30 of the top plate 18 may be made from the same material as the conduit 70 and may have the same thickness as the wall 72 of the conduit 70.

The size and shape of screed plug 10 and the various parts of the screed plug 10 discussed above may vary depending on the size and shape of the conduit 70 with which the screed plug 10 will be used. Preferably, the external diameter of the top plate 18 will be selected to correspond to the external diameter of the conduit 70. In addition, the external diameter of the body 24 will be selected to correspond to the internal diameter of the conduit 70. For example, where the screed plug 10 is to be used in a conduit 70 having an external diameter of 110 mm and an internal diameter of approximately 102.6 mm and a wall thickness of approximately 3.7 mm, the top plate 18 will preferably have a diameter of 110 mm to match the external diameter of the conduit 70. The body 24 will preferably have a diameter of approximately 102.6 mm substantially matching the internal diameter of the conduit 70. As discussed below, the body 24 may have a size (for example, in the example given above, the body 24 may have an external diameter of 103 mm or 103.5 mm) that is slightly larger than the internal diameter of the conduit 70 in order to achieve an interference type fit between the side wall 16 of the body 24 and the wall 72 of the conduit 70. The dimensions of other parts of the screed plug 10 need not correspond in the same way to the conduit 70. However, as an example, the height of the body 24 may be 70 mm. The height of the winged nut 46 including the bottom plate 48 may be 40 mm. The handle 22 may be 100 mm long and the shaft 38 may have a diameter of 8 mm including the screw thread 40 with the screw thread 54 of the winged nut 46 being compatible with the screw thread 40 of the shaft 38. The thickness of each of the first disc 28 of the top plate 18, the second disc 30 of the top plate 18, and the bottom plate 48 may be, for example, 3.7 mm. It will be apparent from the method explained below that the dimensions such as the height of the body 24 may be selected in light of the intended height of the laid screed, tiles, and the like, in the vicinity of the conduit 70. The length of the shaft 38 of the handle 22 may also be varied depending on the height of the body 24.

The body 24 of the screed plug 10 is made from a resiliently deformable material which engages or presses against the internal wall of the conduit 70 to hinder or resist movement of the screed plug relative to the conduit, for example, to hinder or resist removal of the plug from the conduit 70 and insertion of the plug into the conduit 70. This may be achieved due to an interference or friction fit between the side wall 16 of the body 24 and the wall 72 of the conduit 70. As the body 24 is made from a resiliently deformable material, when it has an external diameter which is about the same as or slightly larger than the internal diameter of the conduit 70, the resiliently deformable material will be slightly compressed when the screed plug 10 is inserted into the conduit 70. The resilience of the material will cause it to push outward against the wall 72 of the conduit 70 and friction will act to hold the screed plug 10 in place and to resist movement of the screed plug 10. This has advantages in assisting with the positioning of the screed plug 10 in the method described below and also as the close fit between the screed plug 10 and the wall 72 of conduit 70 will also reduce the likelihood of liquids and other material entering the conduit 70 while the screed plug 10 is in place in the conduit 70.

Suitable materials for use in forming the body 24 of the screed plug 10 include polyethylene, polythene (PE), poly(methylene), polyethylene sheet, high density polyethene (HDPE), polystyrene (PS), expanded polystyrene, extruded polystyrene foam (XTR), 100% closed cell foam (XPS), closed cell foam (EVA), ethylene vinyl acetate and blended copolymers, natural or synthetic cork, compressed paper, OEM rubber, nitrile (NBR) rubber, Buna-N and acrylonitrile butadiene rubber, and polypropylene (PP) also known as polypropene. Of these, materials such as high density polyethene (for example, in the form of a high density polyethene foam) and polystyrene have an advantage as cement does not readily adhere to them. In that regard, surfaces of the screed plug 10 may be coated with releasing agents to reduce the likelihood of concrete and screed adhering to the screed plug 10.

In the embodiment described above, the body 24 of the screed plug 10 is made from the resiliently deformable material. However, other arrangements are possible. For example, the screed plug 10 may have a core (not illustrated) made from a core material with the resiliently deformable material provided surrounding that core material. In such a case, the core material may be different to the resiliently deformable material. Alternatively, the screed plug 10 may have an internal wall with the resiliently deformable material forming a layer over the wall so that when the screed plug is inserted the conduit 70, the resiliently deformable material is “sandwiched” between the internal wall of the screed plug 10 and the wall 72 of the conduit 70.

The conduit 70 may be made from polyvinylchloride (PVC) or other materials such as concrete or clay. The top plate 18 (including both the first disc 28 and the second disc 30, or being an integrally formed single piece) may be made from PVC or other similarly hard materials, such as hard plastics materials, metal, wood, or the like. Softer materials may also be suitable. However, softer materials may not perform as well as guides for screeding in the screeding method described below.

It will be appreciated that a top plate 18 having an external diameter which is the same as the external diameter of the conduit 70 will not substantially alter the overall width profile of the conduit 70 when the screed plug 10 is fully inserted into the conduit 70. In that case, the top plate 18 will not extend outward beyond the wall 72 of the conduit 70. In addition, while different thicknesses for the top plate 18 are possible, it is preferable to limit the thickness of the top plate 18 at least where it makes contact with the conduit 70 when fully inserted. Limiting the thickness of the top plate 18 at least where it makes contact with the conduit 70 when fully inserted will also reduce the impact the screed plug 10 has on the overall profile conduit 70 and will have advantages in the screeding method described below. For example, if the top plate 18 is 3 mm thick where it makes contact with the wall 72 of the conduit 70, the change in height due to the insertion of the screed plug 10 into the opening of the conduit will be 3 mm.

In the embodiment described above, the receiving member 44 is a winged nut 46. The wings 47 of the winged nut 46 assisting in stabilising the winged nut within the body 24. In addition, the winged nut 46 is integrally formed with the bottom plate. In addition, the winged nut 46 is separated from the top plate 18. However, other arrangements are possible. For example, the receiving member 44 may be in the form of a tube (not illustrated) which extends from the top plate 18 to the bottom plate 48. In that case, the receiving member 44 may be fixed to one or other or both of the top plate 18 and the bottom plate 48. For example, the orientation of the winged nut 46 shown in FIG. 9 could be reversed such that the winged nut abuts or is fixed to the bottom of the second disc 30. In that case, the winged nut 46 and the second disc 30 could be integrally formed or the whole of the top plate 18 and the winged nut 46 could be integrally formed. It will be apparent that in some arrangements a bottom plate could be absent.

In the embodiment described above, a handle 22 which can be moved from the first position to the second position is provided. The handle 22 has the advantage that it can be moved into the second position to assist in manipulating or moving the screed plug 10 when necessary and then moved into the first position when necessary such that it does not interfere with other processes being carried out such as the levelling process when laying concrete or screed (see below). If such a movable handle is not provided, other strategies for manipulating or moving the screed plug may be provided. It will be appreciated that any structure intended to assist in manipulating or moving the screed plug 10 preferably does not extend above the surface 12 of the screed plug 10 as this may interfere, for example, with the levelling processes described in the method below. For example, a fixed handle or nob could be formed in a recess formed in the top plate 18. Alternatively, an opening or openings (or recess or recesses) which can be engaged by a removable handle could be provided in the surface of the top plate 18. Such a removable handle could have a bayonet-type engagement with the top plate. Also, a recessed tab for griping or a recessed anchor for a hook can be provided in the top plate 18. In such cases, a removable cap or cover may be necessary to cover the recess and such structures so that during the laying of concrete or screed any recesses do not inadvertently become filled with concrete or screed.

### Screeding Guide

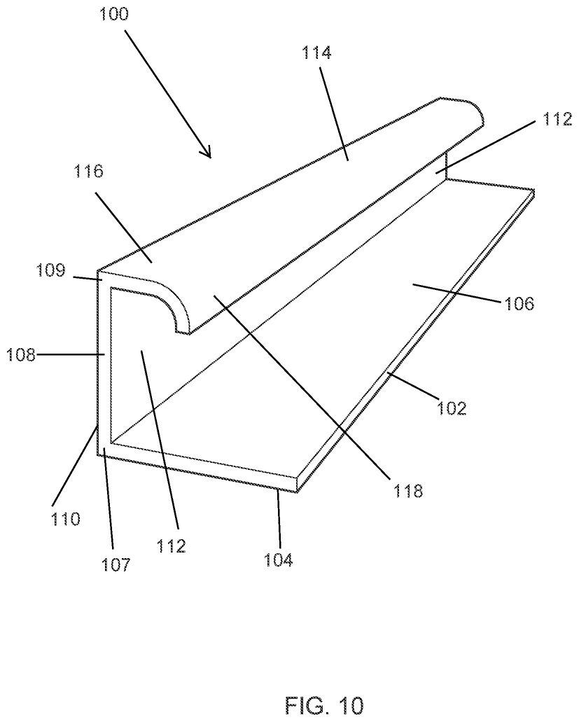

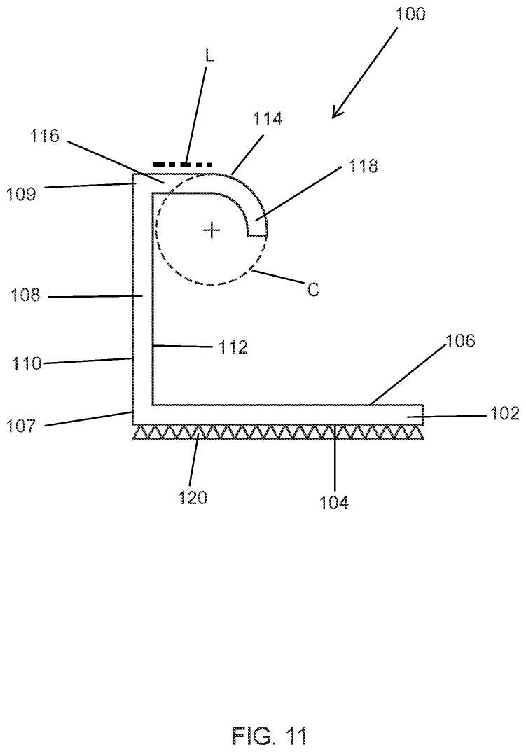

FIG. 10 shows a perspective view of a screeding guide 100 which can be used with the screed plug 10 and in the screeding method described below. FIG. 11 shows a cross section through the screeding guide 100. The screeding guide 100 includes a base 102 having a first side 104 and a second side 106, a side wall 108 having a first side 110 and a second side 112, and a guide arm 114 having a straight portion 116 and a curved section 118. An adhesive layer 120 may be provided along the first side 104 of the base 102 for fixing the screeding guide 100 in position on a surface. An adhesive layer (not illustrated in FIG. 11) could also be provided on the first side 110 of the side wall 108 (see the second embodiment discussed below). The adhesive layer 120 may be, for example, a self-adhesive tape.

As will be apparent from the screeding method described below, in use, the screed guide 100 is positioned (directly or indirectly) on a substrate on which screed, concrete or other material is to be laid. In the embodiment shown in FIG. 10, the first side 104 of the base 102 will be toward the substrate and therefore it is also referred to as the substrate side 104 of the base 102. In the screeding process described below, the screed, concrete or other material will be spread directly or indirectly on the second side 106 of the base 102 and the second side 112 of the side wall 108. Therefore, in the following description, the second side 106 of the base 102 will also be referred to as the screed side 106 of the base 102. In addition, in the screeding method described below, depending on the order of steps, the screeding guide 100 may be positioned against a wall element or a wall element may be positioned against the screeding guide 100. Therefore, in the following, the first side 110 of the side wall 108 is also referred to as the wall side 110 of the side wall 108.

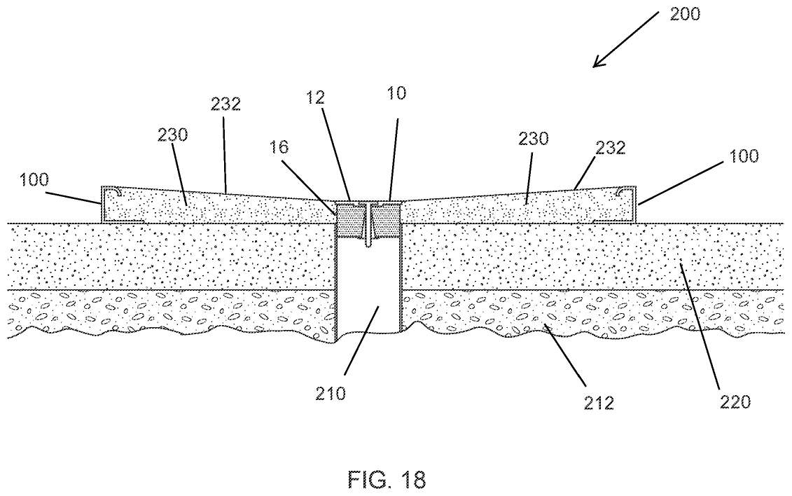

The dimensions of the screeding guide 100 are not particularly limited and will be determined by the intended use of the screeding guide as discussed in more detail below. However, as an example, the width of the base 102 (the length from the side wall 108 to the free end of the base 102) may be 30 mm and the side wall 108 may be 25 mm high. The length of the straight portion 116 from the side wall 108 to the point at which the straight portion 116 meets the curved portion 118, corresponding to dashed line L in FIG. 11, may be 7 mm, for example. In addition, the curve of the outer surface of the curved portion 118 of the guide arm 114 may correspond to the curve of a circle having a radius of 7 mm as indicated by the dashed circle C in FIG. 11. It will be appreciated that the length of the screeding guide 100 is not limited and can be selected in light of where the screeding guide will be used. The thickness of the base 102, the side wall 108 and the guide arm 114 may each be 1.5 mm, for example. The screeding guide 100 may be made of metal, for example, an extruded aluminium, or a plastics material. In addition, the guide arm 114, the side wall 108 and the base 102 may be perforated. For example, the guide arm 114 may have perforations or holes (not shown in the figures) having a size in the range of from 1 to 3 mm. The perforations will allow air and the screeding material to pass through and allow the screeding material to be spread evenly and reduce the likelihood of pockets of air forming under the guide arm 114. Therefore, the size of the perforations or holes can be selected in light of this. It will be appreciated that where the screed is to be laid on one side of the side wall 108 only (for example, the side of the side wall 108 directed toward the conduit 70—see FIG. 18), perforations which allow the screed to pass through the side wall 108 are not preferable. However, fine holes which would allow air to pass through while not allowing the screeding material to pass through would be possible.

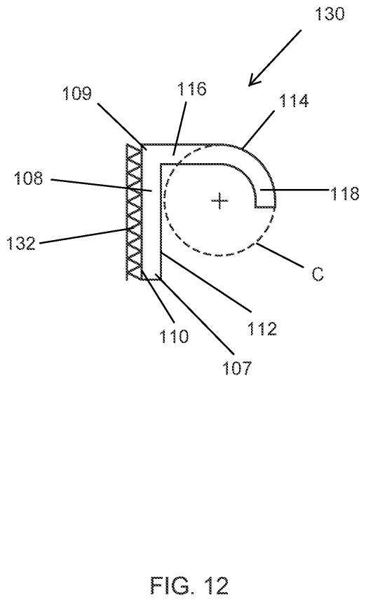

FIG. 12 shows a cross-section through a second embodiment of a screeding guide 130. Features of the screeding guide 130 which are common with the screeding guide 100 will be given the same reference numbers. As will be apparent from FIG. 12, the screeding guide 130 differs from the screeding guide 100 as it does not have a base 102. In addition, in this second embodiment, an adhesive layer 132 is provided on the wall side 110 of the side wall 108. The adhesive layer 132 can be used to fix the screeding guide 130 to a wall or other structure adjacent to the area being screeded.

The screeding guide 130 may have the same dimensions as those of the screeding guide 100.

In the embodiments described above, the guide arm has a straight portion and a curved portion. The curved portion provides a surface against which a screeding rail (see the method below) can be rested and is able to provide a point of contact for differing angles with the screed rail. However, other arrangements for the guide arm are possible. For example, the straight portion may be absent and the curved portion may be connected directly to the side wall 108. In that case, the curved portion may have the same circular radius of 7 mm described for the embodiments above, or the curved portion may follow the arc of a larger radius circle or may follow the arc of an ellipse or an oval. The straight portion may be connected to the side wall at an angle and the angle may be such that the incline of the straight wall substantially corresponds to the intended slope of the screed. In such a situation, the curved portion may not be necessary. In the example given above, the length of the straight portion (7 mm) corresponds to the radius (7 mm) of the circle corresponding to the curve of the outer surface of the curved portion. However, the guide arm is not limited to this one to one relationship and the straight portion may be longer or shorter than the radius of the circle corresponding to the curve of the curved portion.

### Screeding Method

In the following, embodiments of a screeding method in which the screeding plug 10 and the screeding guide 100, 130 may be use are described.

FIG. 13 shows a cross-section through a part of a construction site 200 having a conduit already installed. In this example, the conduit 70 is a drain pipe 210 for a bathroom. The drain pipe 210 has already been laid in the ground 212. In FIG. 13, the surface 214 of the ground 212 is shown as being flat, but the surface 214 of the ground in such situations is typically irregular. A screed plug 10 as described above has been fully inserted into the open end 216 of the drain pipe 210. In addition, the handle 22 of the screed plug 10 is within the recess 20 of the top plate 18. Beams 217 of timber formwork 218 have been positioned on the ground 212 prior to the laying of a concrete substrate 220 (described below). The drain pipe 210 has been cut to the desired height and, with the screed plug 10 inserted into the drain pipe 210, the top surfaces 222 of beams 217 of the formwork 218 and the top surface 12 (the first surface 12) of the screed plug 10 are aligned (see dashed line GL which represents the intended level of the concrete substrate which will be laid in the area CA—see below) with each other to assist with the levelling of the concrete substrate 220 described below.

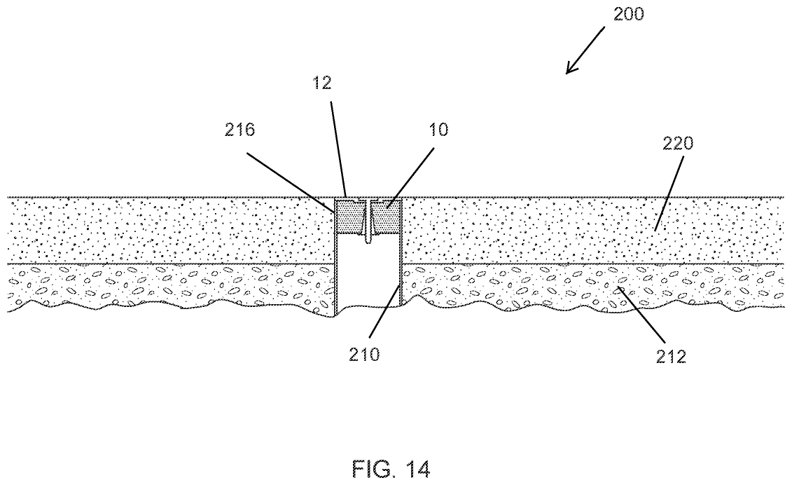

FIG. 14 shows the construction site 200 after the concrete substrate or base 220 has been laid around the drain pipe 210. During the laying of the concrete substrate 220, wet concrete is poured in the area CA between the beams 217 of the formwork 218 and around the drain pipe 210. A rail or beam (not shown) is passed over the surface of the wet concrete using the top surfaces 222 of the beams 217 and the top surface 12 of the screed plug 10 as a guide to level the surface of the wet concrete. After the wet concrete has been levelled, the wet concrete is allowed to dry giving the arrangement shown in FIG. 14.

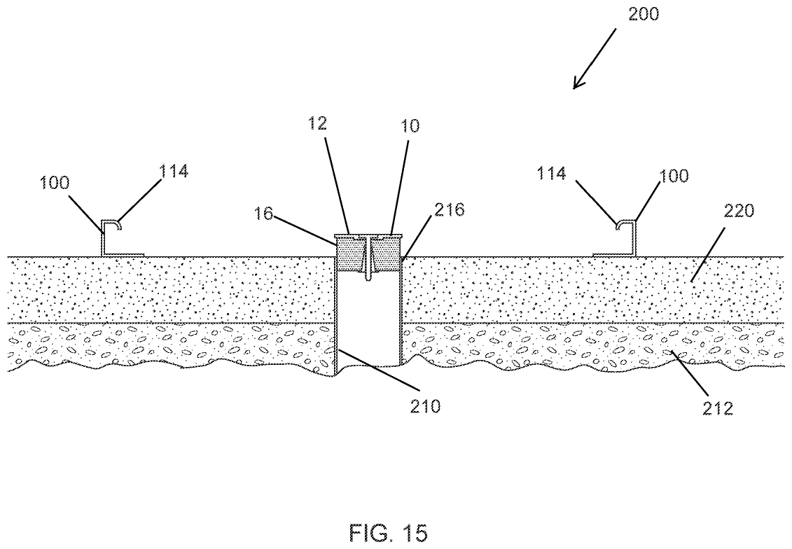

FIG. 15 shows a cross-section of the construction site 200 as shown in FIG. 14 with screeding guides 100 positioned on the concrete substrate 220. The screeding guides 100 are arranged with the guide arms 114 directed toward the drain pipe 210. In addition, the screed plug 10 has been moved upward and is partially withdrawn from the drain pipe 210 compared with the arrangement shown in FIG. 14. To move the screed plug 10 from the position show in FIG. 14 to the position shown in FIG. 15, the handle 22 is raised from the recess 20 (see FIG. 7) by un-screwing the handle 22. The handle 22 can then be used to pull the screed plug 10 upward (for example, see FIG. 8 or FIG. 9). Thereafter, the handle 22 is screwed downward into the recess 20, thereby achieving the arrangement shown in FIG. 15.

In the arrangement shown in FIG. 15 to 18, the position of the screed plug 10 in the conduit is maintained due to the engagement of resiliently deformable material of the side wall 16 of the screed plug 10 and the wall 72 of the conduit 70. The engagement of the side wall 16 and the wall 72 hinders movement of the screed plug 10 relative to the conduit 70. In this way, it is possible for the top surface 12 of the screed plug to act as a guide during the levelling of the screed material (see below).

It will be appreciated that if the screed plug 10 did not have the handle 22, it might be possible to raise the screed plug 10 using a tool (or tools) such as the head of a screw driver as a lever inserted between the top plate 18 and the wall of the conduit 70. However, in that case it may be more difficult to raise the screed plug 10 where there is an interference type fit between the screed plug 10 and the wall 72 of the conduit 70 or if concrete has become adhered to a part of the top plate 18 during the laying of the concrete substrate.

As discussed above, the dimensions of the screeding guide 100, 130 are not particularly limited. However, the dimensions of the screeding guide 100, 130 may be selected so that the laid screed will have a slope suitable for draining liquids. For example, if the screeding guide is positioned away from a drain pipe 210, the height of the side wall 108 may be higher than compared with a screeding guide which is to be positioned closer to the drain pipe 210. A typical slope for draining liquids is a fall of 10 mm per meter.

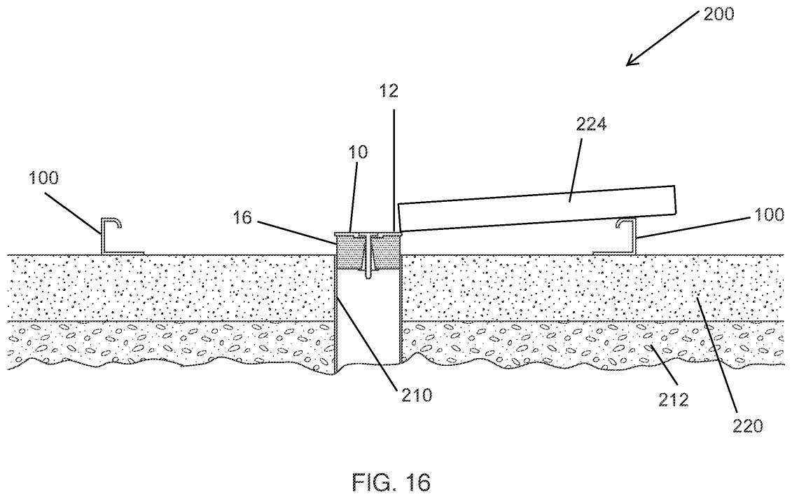

FIG. 16 shows the arrangement shown in FIG. 15 with a screeding rail 224 resting upon the screeding guide 100 and on the top surface 12 of the screed plug 10. This illustrates the difference in relative heights of the top of the screeding guide 100 and the top surface 12 of the screed plug 10. The position of the screed plug 10 can be adjusted in order to establish a suitable slope for the screed using a spirit level, for example. In the arrangement shown, the screeding rail 224 extends over the top of the screeding guide 100 to the area on the wall side of the screeding guide 100.

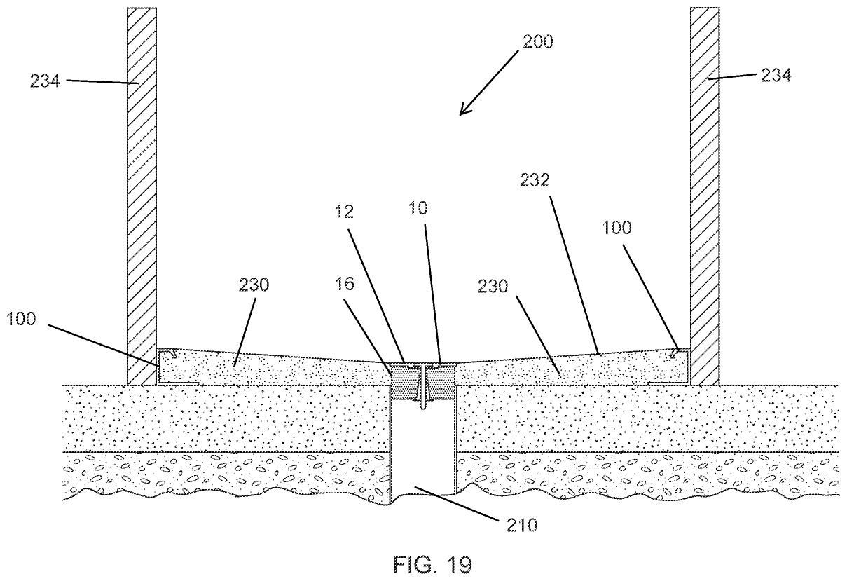

In the embodiment shown in the figures, the screeding guide 100 is positioned at the perimeter of the screeding area corresponding to the position of the wall elements (see FIG. 19). This has the advantage of defining the area in which the screed will be laid and also the position of the wall elements. However, it would also be possible to position the screeding guide 100 at an intermediate position and lay screeding material on the side of the screeding guide 100 toward the drain pipe 210 and also on the side of the screeding guide 100 away from the drain pipe 210 which is facing toward the wall element or where the wall element is to be positioned.

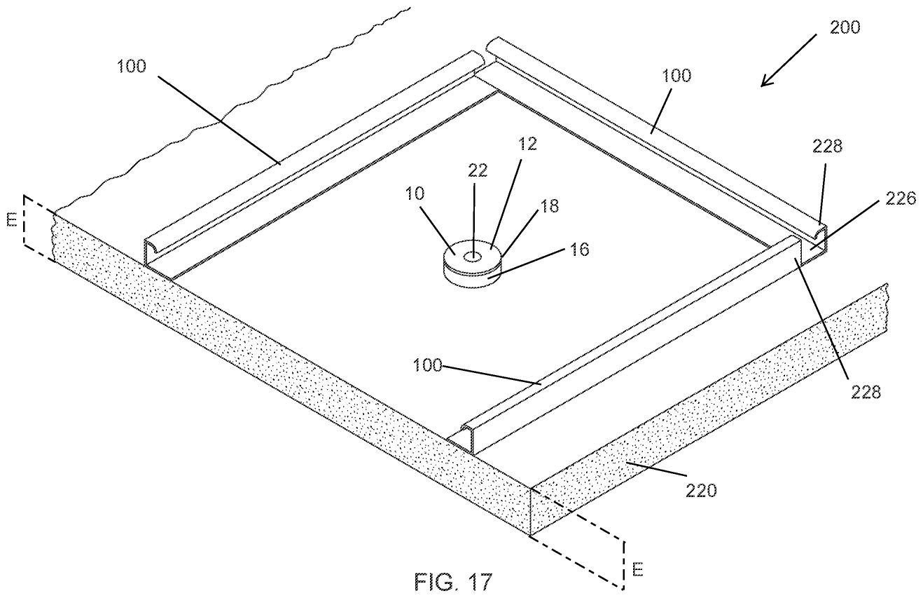

FIG. 17 shows an isometric view of the construction site 200. As can be seen in FIG. 17, three screeding guides 100 have been positioned on the concrete substrate 220. The three screeding guides 100 are arranged at the perimeter of the area to be screeded. FIG. 17 includes a cross-section along the plane E-E. A fourth screeding guide 100 (not shown in FIG. 17) would also be provided along the plane E-E to thereby establish four sides of the area to be screeded. In the arrangement shown in FIG. 17, small openings 226 are present where the ends 228 of the screeding guides 100 meet. It should be noted that the ends 228 of the screeding guides 100 can be formed or cut to avoid such openings 226. For example, the ends of the bases 102 and the guide arms 114 can be cut (or formed) with corresponding diagonal edges (for example, each at 45 degrees) so that the side walls 108, the bases 102, and the guide arms 114 each abut when arranged in the configuration illustrated in FIG. 17. Alternatively, preformed corner pieces or mitres (not shown) formed to match the ends of each of the screeding guide 100 where they meet can be positioned at the ends of the screeding guides 100 to avoid the presence of the opening 226 or the need to cut or form the screeding guides 100, 130 with diagonal or matching edges.

FIG. 18 shows the construction site 200 after screed 230 has been laid in the area between the screeding guides 100 and the screeding plug 10 and then levelled, for example, using a screeding rail 224 as illustrated schematically in FIG. 16. In the screeding process, the guide arms 114 of the screeding guides 100 and the top surface 12 of the top plate 18 of the screeding plug 10 are used as guides for levelling the screed using the screeding rail 224 (see FIG. 16). Due to the differences in height of the top surface 12 of the screed plug 10 and the screeding guides 100, the surface 232 of the screed 230 slopes toward the screed plug 10 and the opening of the drain pipe 210. In addition, as the screed plug 10 remains within the drain pipe 210, the screeding material is prevented from entering the drain pipe 210.

FIG. 19 shows the construction site 200 after wall elements 234 have been installed adjacent to the screeding guides 100. The screeding guides 100 remain in position and have not been removed. The screeding plug 10 is still in position in the drain pipe 210. The wall elements 234 shown in FIG. 19 correspond to walls of a room. However, the wall elements 234 would also correspond to other structural elements which may be found in an area which includes a drain such as a shower, a tiled bath, a bathroom or a laundry. For example, the wall element 234 may be a step or a hob which surrounds or forms one or more sides of a shower recess.

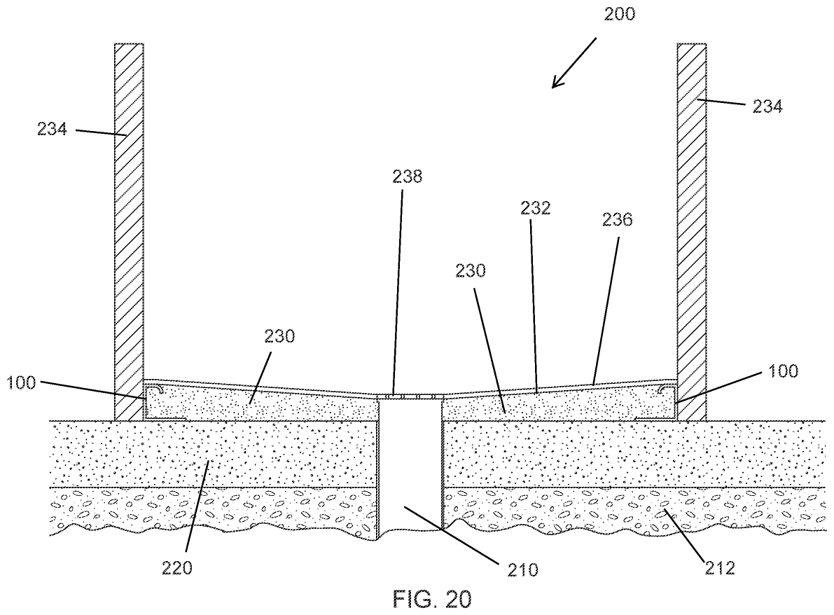

FIG. 20 shows the construction site 200 after tiles 236 have been installed over the surface 232 of the screed 230 and a drain cover 238 has been positioned over the drain pipe 210.

It will be appreciated that the above described process illustrates an example of the screeding method and examples of the use of the screeding guide 100 and the screed plug 10. Not every step of laying the concrete substrate 220 or the screed 230 has been described. For example, a membrane (not illustrated) for controlling water penetration may be installed above the concrete substrate 220 or between the screed 230 and the tiles 236. In addition, an adhesive (not shown) may be applied to the surface of the concrete substrate 220 prior to screeding. Adhesive or other materials (not shown) may be applied between the wall elements 234 and the wall sides 110 of the side walls 108 of the screeding guide 100. In the above method, the concrete substrate 220 was laid directly on to the ground, but the above method is not limited to such an arrangement and would also be suitable for use in situations where the concrete substrate is a floor in a multistorey building.

In the above method, the wall elements 234 are installed after the screed 230 has been laid and levelled. There are advantages to installing the wall elements 234 after the screed 230 has been laid and levelled. For example, when using a screeding rail 224, the screeding rail 224 can be moved freely back and forth over the top of the screeding guide 100 (see for example FIG. 16). When wall elements 234 or walls are in place before the screed 230 is laid, the walls will limit the range of movement of the screeding rail 224 and in confined spaces such as in small bathrooms or shower recess, this may make the screeding process more difficult. However, in the method described above, the walls may be positioned beside the screeding guide before the screed is laid. Alternatively, the wall elements 234 may be installed before the screeding guides 100 are installed. In such situations, the screeding guide 130 illustrated in FIG. 12 may be used. In that case, the adhesive layer 132 can be used to hold the screeding guide 130 in position against the wall element 234.

It will also be appreciated that when screeding a surface in a pre-existing building (for example, during a renovation), it is likely that the wall elements will already be in position. In such situations, the screeding guides 100, 130 may be used with existing walls.

In the method described above, the screeding guide 100, 130 and the screeding plug 10 described above are used as guides for levelling the screed 230. However, while this combination is advantageous, it would be possible to carry out the method using the rim of the opening of the drain pipe 210 as a guide in place of the top surface 12 of the screed plug 10. In that situation, rather than cutting the drain pipe to the desired height for the concrete substrate, the drain pipe 210 could be cut to the desired height for the laid screed. The screeding rail could then be aligned with the top of the guide arm 114 of the screeding guide 100 and the rim of the drain pipe 210. Traditional methods (such as using a rag) could be used to prevent material from entering the drain pipe 210. However, in that approach, some of the advantages of the method which uses the screed plug 10 will be missed. For example, when laying the concrete substrate, the drain pipe 210 will extend above the level of the wet concrete and be an obstacle around which the rail or beam used for levelling will have to be manoeuvred.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### Additional Clauses

Also disclosed herein is:

1. A screed plug for placement in an open end of a conduit, the screed plug comprising:
a first surface;
a second surface; and
at least one side wall extending between the first surface and the second surface;
a recess formed in the first surface; and
a handle for manipulating the screed plug, the handle being movable from at least a first position within the recess and a second position projecting from the recess.

1. A screed plug for placement in an open end of a conduit, the screed plug comprising:
a rigid top plate;
a second surface; and
at least one side wall extending between the top plate and the second surface;
a recess formed in the top plate; and
a handle for manipulating the screed plug, the handle being houseable within the recess and being reversibly movable from at least a first position within the recess and a second position projecting from the recess.

2. The screed plug according to claim 1, wherein at least a part of the at least one side wall comprises a resiliently deformable material for engaging an internal wall of the conduit to hinder movement of the screed plug relative to the conduit.

3. The screed plug according to claim 2, wherein the resiliently deformable material hinders movement of the screed plug relative to the conduit due to an interference fit between the at least one side wall and the internal wall of the conduit.

4. The screed plug according to claim 1, further comprising a body bounded at least partially by the top plate, the second surface and at least a part of the at least one side wall.

5. The screed plug according to claim 4, wherein the body comprises a resiliently deformable material.

6. The screed plug according to claim 2, wherein the resiliently deformable material is formed from any one of: polyethylene, polythene (PE), poly(methylene), polyethylene sheet, high density polyethene (HDPE), polystyrene (PS), expanded polystyrene, extruded polystyrene foam (XTR), 100% closed cell foam (XPS), closed cell foam ethylene vinyl acetate (EVA) and blended copolymers, natural or synthetic cork, compressed paper, OEM rubber, nitrile (NBR) rubber, Buna-N and acrylonitrile butadiene rubber, and polypropylene (PP).

7. The screed plug according to claim 1, wherein the handle is in the form of a screw having a head and a shaft and the handle is moved from the first position to the second position by rotating the handle.

8. The screed plug according to claim 7, further comprising a receiving member into or onto which the shaft of the handle is reversibly screwed.

9. (canceled)

10. The screed plug according to claim 1, further comprising a bottom plate, a bottom surface of the bottom plate forming part of the second surface.

11. A screeding method for screeding an area including a conduit having an opening, the method comprising the steps of:
arranging at least one screeding guide in an area to be screeded,
covering the opening of the conduit with a screed plug according to claim 1,
putting a screeding material on the area to be screeded,
levelling a surface of the screeding material using a beam;
wherein, during the step of levelling, a height of the screeding material is established by aligning the beam with a surface of the at least one screeding guide and a guide associated with the screed plug.

12. The screeding method according to claim 11, wherein the guide associated with the screed plug is a surface of the screed plug.

13. The screeding method according to claim 11,
wherein the step of covering the opening of the conduit is carried out before the step of arranging the at least one screeding guide, and
wherein the step of covering the opening of the conduit includes adjusting a position of the screed plug such that the surface of the screed plug corresponds to an intended height of a substrate at the conduit.

14. The screeding method according to claim 13, further comprising the step of:
forming the substrate around the conduit by laying a substrate material around the conduit and levelling the surface of the substrate material using the surface of the screed plug as a guide for the height of the substrate at the conduit.

15. The screeding method according to claim 14, further comprising, after the step of forming the substrate, further adjusting the position of the screed plug such that the surface of the screed plug corresponds to an intended height of laid screed at the conduit.

16. The screeding method according to claim 11, further comprising the steps of:
positioning a wall element directly or indirectly against the at least one screeding guide.

17. (canceled)

18. The screeding method according to claim 11, wherein the step of arranging the at least one screeding guide in the area to be screeded includes fixing the screeding guide directly or indirectly to a wall element.

19. The screeding method according to claim 11, wherein the screeding guide comprises:
a wall member having a top and a bottom; and
a guide arm connected at a first end to the wall member.

20.-24. (canceled)

25. The screeding method according to claim 11, wherein the steps of further adjusting the position of the plug includes moving the handle of the screed plug from the first position within the recess to the second position projecting from the recess.

26. A screed plug for placement in an open end of a conduit, the screed plug comprising:
a rigid top plate;
a second surface; and
at least one side wall extending between the top plate and the second surface;
a recess formed in the top plate;
a body bounded at least partially by the top plate, the second surface and at least a part of the at least one side wall, and
a handle for manipulating the screed plug, the handle being houseable within the recess and being reversibly movable from at least a first position within the recess and a second position projecting from the recess,
wherein at least a part of the at least one side wall comprises a resiliently deformable material for engaging an internal wall of the conduit to hinder movement of the screed plug relative to the conduit.

27. A screed plug for placement in an open end of a conduit, the screed plug comprising:
a rigid top plate;
a second surface; and
at least one side wall extending between the top plate and the second surface;
a recess formed in the top plate;
a handle for manipulating the screed plug, the handle being houseable within the recess and being reversibly movable from at least a first position within the recess and a second position projecting from the recess, and
a body bounded at least partially by the top plate, the second surface and at least a part of the at least one side wall,
wherein the handle is in the form of a screw having a head and a shaft and the handle is moved from the first position to the second position by rotating the handle.
